(19) United States
(12) Patent Application Publication
(10) Pub. No.: US 2014/0024309 A1
(43) Pub. Date: Jan. 23, 2014

(54) NFC RADIO CONTROL IN A MOBILE DEVICE

(71) Applicants: Siva G. Narendra, Portland, OR (US); Donald Allen Bloodworth, Camas, WA (US)

(72) Inventors: Siva G. Narendra, Portland, OR (US); Donald Allen Bloodworth, Camas, WA (US)

(73) Assignee: TYFONE, INC., Portland, OR (US)

(21) Appl. No.: 13/553,794

(22) Filed: Jul. 19, 2012

(51) Int. Cl. H04B 5/00; H04W 88/02

(52) U.S. Cl. 455/41.1

(57) ABSTRACT

A mobile device includes a near field communications (NFC) radio and at least one sensor. A radio frequency (RF) signal emission status is modified in response to a change in state of the mobile device as determined by sensor data. Sensors may include motion sensors, light sensors, location sensors, time sensors, and others.

### FIELD

The present invention relates generally to mobile devices, and more specifically to mobile devices with near field communications (NFC) radios.

### BACKGROUND

Near field communications (NFC)-enabled devices typically communicate with each other over short distances using radio frequency (RF) signals. NFC-enabled devices may operate in active or passive modes. For example, when operating in a passive mode, one NFC-enabled device operates as a “reader” and emits an RF signal to communicate with a second NFC-enabled device that operates as a “tag.” The second NFC-enabled device then communicates with the first NFC-enabled device by modulating the existing RF signal. Also for example, when operating in an active mode, both NFC-enabled devices emit RF signals. An NFC-enabled device may also communicate with a non-NFC-enabled device such as a plastic card or smart poster.

NFC-enabled mobile devices consume power when they emit RF signals. When a battery powered mobile device operates in an active mode or as a reader device in a passive mode, constant emission of RF signals reduces battery life.

### BRIEF DESCRIPTION OF THE DRAWINGS

FIG. 1 shows a mobile device with a near field communications (NFC) radio that changes an emission status of an RF signal in response to sensor data;

FIG. 2 shows a mobile device emitting an RF signal in response to motion;

FIG. 3 shows a mobile device emitting an RF signal in response to light changes;

FIG. 4 shows a block diagram of a mobile device in accordance with various embodiments of the present invention;

FIG. 5 shows a mobile device with a near field communications (NFC) radio on a circuit board in accordance with various embodiments of the present invention;

FIG. 6 shows a mobile device with an NFC radio in a semiconductor chip in accordance with various embodiments of the present invention;

FIG. 7 shows a mobile device with an NFC radio on a subscriber identity module (SIM) card in accordance with various embodiments of the present invention;

FIG. 8 shows a mobile device with an NFC radio on a memory card in accordance with various embodiments of the present invention;

FIG. 9 shows a mobile device with an NFC radio on a universal serial bus (USB) device in accordance with various embodiments of the present invention;

FIG. 10 shows a mobile device with a dock connector and a device compatible with the dock connector that includes an NFC radio in accordance with various embodiments of the present invention; and

FIGS. 11 and 12 show flowcharts of methods in accordance with various embodiments of the present invention.

### DESCRIPTION OF EMBODIMENTS

In the following detailed description, reference is made to the accompanying drawings that show, by way of illustration, various embodiments of an invention. These embodiments are described in sufficient detail to enable those skilled in the art to practice the invention. It is to be understood that the various embodiments of the invention, although different, are not necessarily mutually exclusive. For example, a particular feature, structure, or characteristic described in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

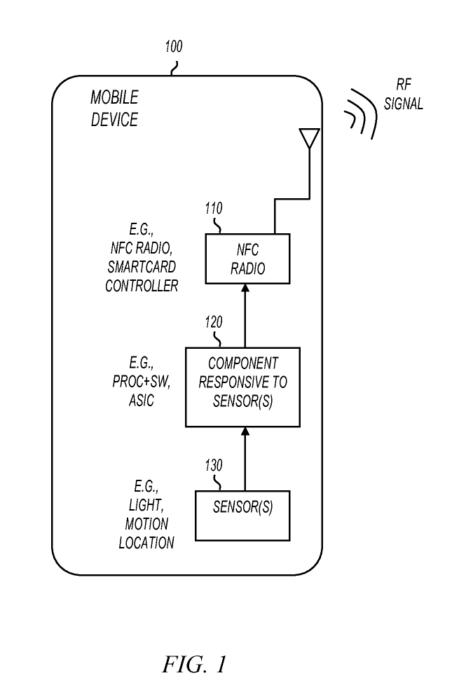

FIG. 1 shows a mobile device with a near field communications (NFC) radio that changes an emission status of an RF signal in response to sensor data. Mobile device 100 includes NFC radio 110, sensor(s) 130, and component 120 which is responsive to sensor(s) 130. Sensor(s) 130 may include any number or type of sensors. Examples include, but are not limited to, motion sensors such as accelerometers or gyroscopes, ambient light sensors, sound sensors, time sensors, location sensors such as global positioning system (GPS) radios, and the like. Component 120 may be any type of component capable of receiving sensor data and influencing the operation of NFC radio 110. For example, in some embodiments, component 120 includes a processor that executes software instructions. During operation, the processor may collect sensor data, and may also influence the operation of NFC radio 110 in response to the sensor data. In other embodiments, component 120 includes sequential logic devices such as state machines. This may be implemented in any manner without departing from the scope of the present invention. For example, component 120 may be included within an application specific integrated circuit (ASIC). In other embodiments, component 120 may be built into the NFC radio 110.

In operation, component 120 commands NFC radio 110 to change an emission status of an RF signal. For example, in some embodiments, component 120 commands NFC radio 110 to emit, or to stopping emitting, an RF signal based on a change in state of the mobile device that is in turn based at least in part on data received from one or more of sensor(s) 130. For example, sensor(s) 130 may include a motion sensor, and component 120 may receive sensor data indicating motion of mobile device 100. In response to the detected motion, component 120 may command NFC radio 110 to emit an RF signal or to stop emitting an RF signal. Also for example, sensor(s) 130 may includes a light sensor, and component 120 may receive sensor data indicating a change in ambient light. In response to the detected change in ambient light, component 120 may command NFC radio 110 to emit an RF signal or to stop emitting an RF signal. Further, sensor(s) 130 may include multiple sensors of properties (e.g., motion, location, light, time, and others), and component 120 may command a change in an RF signal emission status based on data from multiple sensors. In general, component 120 may command NFC radio 110 to change its operation based on any type or combination of sensor data.

NFC radio 110 may be any radio capable of emitting RF signals compatible with other NFC devices. For example, in some embodiments, NFC radio 110 includes an ISO/IEC 14443 contactless interface capable of emitting an RF signal. Further, NFC radio 110 may have any type of interface to component 120.

In some embodiments, NFC radio 110 is packaged with a secure element in a smartcard controller. In other embodiments, NFC radio 110 communicates with a secure element in a smartcard controller. Examples of smartcard controllers that combine both a secure element and an NFC radio are the “SmartMX” controllers sold by NXP Semiconductors N.V. of Eindhoven, The Netherlands. In some embodiments, the secure element has an ISO/IEC 7816 compatible interface that communicates with other components within mobile device 100 (e.g., component 120), although this is not a limitation of the present invention.

Mobile device 100 may be any type of mobile device capable of including the components shown. For example, in some embodiments, mobile device 100 is a mobile phone. In other embodiments, mobile device 100 is a tablet computer, and in still other embodiments, mobile device 100 is a laptop computer.

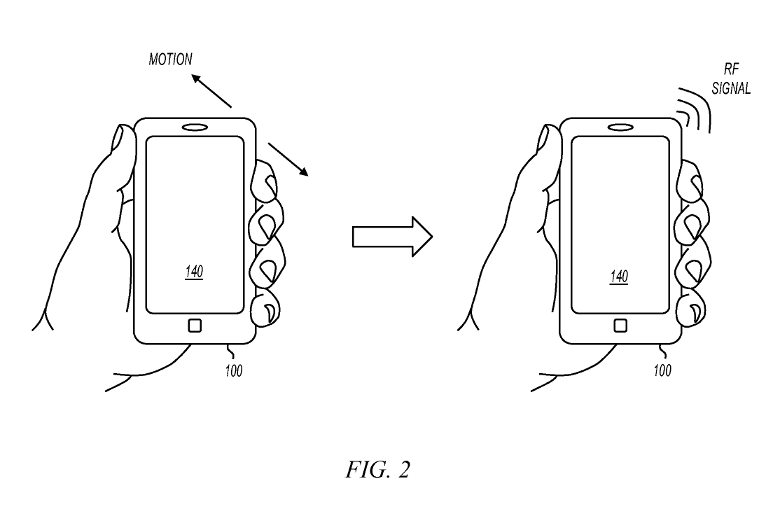

FIG. 2 shows a mobile device emitting an RF signal in response to motion. At the left of FIG. 2, mobile device 100 is shown undergoing motion, and at the right of FIG. 2, mobile device 100 is shown emitting an RF signal in response to the motion. The emission of an RF signal in response to motion is an example of the mobile device changing an RF signal emission status in response to a detected change in state, where the change in state is motion. Embodiments of FIG. 2 represent embodiments in which mobile device 100 includes a motion sensor, and in which component 120 commands NFC radio 110 to emit an RF signal in response to detected motion (the detected change in state).

In some embodiments, the RF signal is emitted only when a certain time profile of sensor values is met, such as when a certain “motion profile” is detected. For example, acceleration in a particular dimension may cause the RF signal to be emitted or stopped from emitting. Also for example, a series of motions occurring over time may cause the RF signal to be emitted or stopped from emitting. The motion profile may be determined by a likely movement scenario prior to an expected use of the NFC features provided by mobile device 100. For example, in some embodiments, the NFC radio may have an antenna situated such that the back of mobile device 100 will be brought near to another NFC-enabled device to effect communications. In these embodiments, the motion profile may include an acceleration component normal to the back face of the mobile device. This may be useful in part because a user will be expected to accelerate the mobile device in that dimension when bringing the mobile device in close proximity to the second NFC-enabled device or a plastic card or a smart poster or other such targets.

Mobile device 100 is shown with display device 140. In some embodiments, display device 140 displays static screen contents during the time period that motion causes emission of the RF signal. In some embodiments, the static screen contents may represent a “lock” screen that displays when the mobile device is inactive. In other embodiments, the static screen contents may simply be a blank screen. In other embodiments, display screen 100 may display an indication that its state has changed, and that it is emitting, or has stopped emitting, an RF signal. Similarly, mobile device 100 may provide a different indication (e.g., blinking LED, haptic feedback, etc.) that its state has changed, and that it is emitting, or has stopped emitting, an RF signal.

In some embodiments, display device 140 is a touch sensitive display device, and a change in state of mobile device 100 causes a change in the RF signal emission status without any user interaction with display device 140. For example, a user may lift mobile device 100 from a table, or remove mobile device 100 from a pocket or purse, without touching display device 140 or otherwise interacting with display device 140. If the motion satisfies the proper motion profile, then RF signal emission may begin without any user interaction with the touch sensitive display device.

A motion profile (or any other time series of sensor values) that will result in a change in RF signal emission status may be specified in any manner. For example, in some embodiments, a mobile device may be pre-programmed with a specific profile of one or a combination of sensor values, such as a motion profile. In other embodiments, a user may specify a specific profile, such as a motion profile. For example, a user may be able to enter a table of acceleration values and dimensions that represent the motion profile. Also for example, mobile device 100 may capture a motion profile when a user moves the device in a motion profile capturing mode. In some embodiments, this may be accomplished when the mobile device enters a motion profile capturing mode, and the user moves the mobile device through one or motions that correspond to that user's expected motions prior to an expected use of the NFC features provided by mobile device 100.

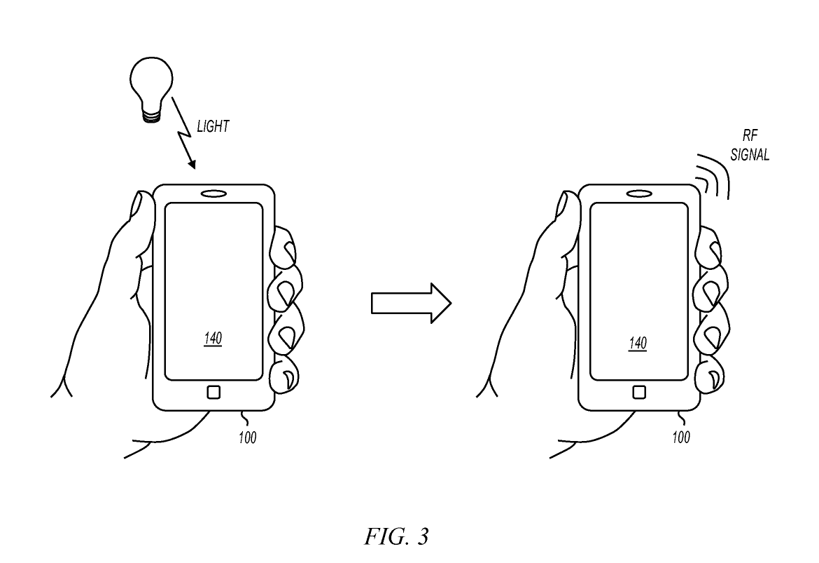

FIG. 3 shows a mobile device emitting an RF signal in response to light changes. The operation shown in FIG. 3 is similar to that shown in FIG. 2, except that the mobile device's change in state results from a change in ambient light rather than motion. The emission of an RF signal in response to a change in light is an example of the mobile device changing an RF signal emission status in response to a detected change in state, where the change in state is a change in ambient light. Embodiments of FIG. 3 represent mobile device 100 including a light sensor, and component 120 commanding NFC radio 110 to emit an RF signal in response to data from a light sensor (the detected change in state).

As described above with reference to FIG. 2, the operation depicted in FIG. 3 may be performed with or without a change in the content displayed on display device 140. Further, the operation depicted in FIG. 3 may be performed without any user interaction with display device 140. Although FIGS. 2 and 3 show a change in state represented by a single variable, this is not a limitation of the present invention. For example, a combination of a motion profile and a change in ambient light may be required before mobile device 100 changes the RF signal emission status. In some embodiments, a change in mobile device state that includes both satisfaction of a motion profile and a change in ambient light may occur when a user removes mobile device 100 from a pocket or purse and then moves mobile device 100 towards another NFC-enabled device. In some embodiments, a combination of a motion profile and a change in the ambient light profile and one or both of the profiles may be used to change the RF signal emission status.

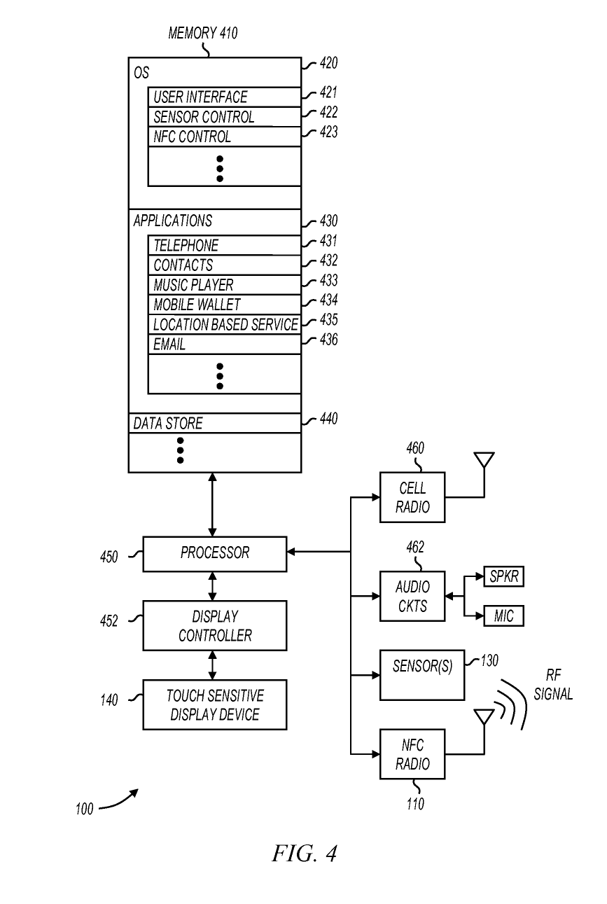

FIG. 4 shows a mobile device in accordance with various embodiments of the present invention. Mobile device 100 is shown including processor 450, memory 410, display controller 452, touch sensitive display device 140, cellular radio 460, audio circuits 462, sensor(s) 130, and near field communications (NFC) radio 110. Mobile device 100 may be any type of mobile device that includes the components shown. For example, in some embodiments, mobile device 100 may be a cell phone, a smartphone, a tablet computer, a laptop computer, or the like.

Processor 450 may be any type of processor capable of executing instructions stored in memory 410 and capable of interfacing with the various components shown in FIG. 4. For example, processor 450 may be a microprocessor, a digital signal processor, an application specific processor, or the like. In some embodiments, processor 450 is a component within a larger integrated circuit such as a system on chip (SOC) application specific integrated circuit (ASIC).

Display controller 452 provides an interface between processor 450 and touch sensitive display device 140. In some embodiments, display controller 452 is integrated within processor 450, and in other embodiments, display controller 452 is integrated within touch sensitive display device 140.

Touch sensitive display device 140 is a display device that includes a touch sensitive surface, sensor, or set of sensors that accept input from a user. For example, touch sensitive display device 140 may detect when and where an object touches the screen, and may also detect movement of an object across the screen.

Touch sensitive display device 140 may be manufactured using any applicable display technologies, including for example, liquid crystal display (LCD), active matrix organic light emitting diode (AMOLED), and the like. Further, touch sensitive display device 140 may be manufactured using any application touch sensitive input technologies, including for example, capacitive and resistive touch screen technologies, as well as other proximity sensor technologies.

Cellular radio 460 may be any type of radio capable of communication within a cellular network. Examples include, but are not limited to, radios that communicate using orthogonal frequency division multiplexing (OFDM), code division multiple access (CDMA), time division multiple access (TDMA), and the like. Cellular radio 460 may operate at any frequency or combination of frequencies without departing from the scope of the present invention. In some embodiments, cellular radio 460 is omitted.

Audio circuits 462 provide an interface between processor 450 and audio devices such as a speaker and microphone. NFC radio 110 is a radio that provides near field communications capability to mobile device 100. Sensor(s) 130 are one or more sensors that detect a change in state of mobile device 100.

Mobile device 100 may include many other circuits and services that are not specifically shown in FIG. 4. For example, in some embodiments, mobile device 100 may include a global positioning system (GPS) radio, a Bluetooth radio, haptic feedback devices, and the like. Any number and/or type of circuits and services may be included within mobile device 100 without departing from the scope of the present invention.

Memory 410 may include any type of memory device. For example, memory 410 may include volatile memory such as static random access memory (SRAM), or nonvolatile memory such as FLASH memory. Memory 410 is encoded with (or has stored therein) one or more software modules (or sets of instructions), that when accessed by processor 450, result in processor 450 performing various functions. In some embodiments, the software modules stored in memory 410 may include an operating system (OS) 420 and applications 430. Applications 430 may include any number or type of applications. Examples provided in FIG. 4 include a telephone application 431, a contacts application 432, a music player application 433, a mobile wallet application 434, a location based services application 435, and an email application 436. Memory 410 may also include any amount of space dedicated to data storage 440.

Operating system 420 may be a mobile device operating system such as an operating system to control a mobile phone, smartphone, tablet computer, laptop computer, or the like. As shown in FIG. 4, operating system 420 includes user interface component 421, sensor control component 422, and NFC control component 423. Operating system 420 may include many other components without departing from the scope of the present invention.

User interface component 421 includes processor instructions that cause mobile device 100 to display desktop screens, recognize gestures, provide navigation between desktop screens and the like. User interface 421 also includes instructions to display menus, move icons, and manage other portions of the display environment.

Sensor control component 422 includes processor instructions that cause processor 450 to interface with sensor(s) 130. For example, processor 450 may read sensor data that indicates a change in state of mobile device 100.

NFC control component 423 includes processor instructions that cause processor 450 to interface with NFC radio 110. For example, processor 450 may command NFC radio 110 to change an RF signal emission status by commanding NFC radio 110 to either emit or stop emitting an RF signal.

In some embodiments, the combination of processor 450, sensor control component 422, and NFC control component 423 represent component 120 (FIG. 1). This combination may detect a change in state of mobile device 100 and command a change in RF signal emission status in response to the change in state of the mobile device. In some embodiments, this occurs without any user interaction other than movement. For example, processor 450 may detect a change in the state of mobile device 100 and command a change in RF signal emission status without any user interaction with touch sensitive display device 140.

Telephone application 431 may be an application that controls a cell phone radio. Contacts application 432 includes software that organizes contact information. Contacts application 432 may communicate with telephone application 431 to facilitate phone calls to contacts. Music player application 433 may be a software application that plays music files that are stored in data store 440.

Mobile wallet application 434 may be a software application that provides access to one or more payment instruments such as credit cards, debit cards, and pre-paid cards. In some embodiments, mobile wallet application 434 communicates with NFC control component 423 or directly with NFC radio 110 within mobile device 100. In other embodiments, mobile wallet application 434 communicates with a smartcard controller that includes NFC radio 110. For example, mobile wallet application 434 may store and access payment identities in a smartcard secure element and allow proximity payments using NFC radio 110.

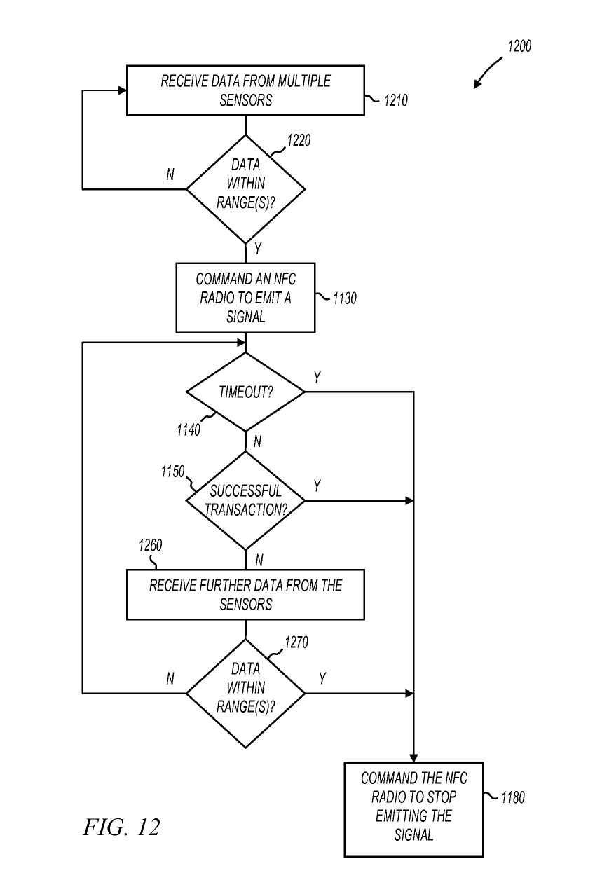

In some embodiments, mobile wallet application 434 communicates with NFC radio 110 after there has been a change in RF signal emission status. For example, after NFC radio 110 is commanded to emit an RF signal, mobile wallet application 434 may communicate with NFC radio 110 to effect provisioning of an identity, the making of a payment, or the like. Further, mobile wallet application 434 may be the source of an indication of a successful transaction (see FIG. 11).

Location based service application 435 may be a software application that provides services based on a location of mobile device 100 as determined through interaction with NFC radio 110. For example, a user may tap mobile device 100 against an NFC tag when entering a store, and location based service application 435 may provide coupon services, mapping services, or any other service that advantageously utilizes location information.

In other embodiments, specific profiles may be programmed for specific actions such as emitting of RF signal as well as the data transmitted and received via the RF signal be passed to a specific application like a mobile wallet application 434 or a location based service application 435 or any such specific application. Choice of the specific application may therefore be determined by the meeting of specific sensor values. Choice of the specific application may also be controlled by the device depending on the nature of the data such as the data format or the header format, subsequent to the meeting of the specific sensor profile.

Each of the above-identified applications corresponds to a set of instructions for performing one or more functions described above. These applications (sets of instructions) need not be implemented as separate software programs, procedures or modules, and thus various subsets of these applications may be combined or otherwise re-arranged in various embodiments. For example, telephone application 431 may be combined with contacts application 432. Furthermore, memory 410 may store additional applications (e.g., video players, camera applications, etc.) and data structures not described above.

It should be noted that device 100 is presented as an example of a mobile device, and that device 100 may have more or fewer components than shown, may combine two or more components, or may have a different configuration or arrangement of components. For example, mobile device 100 may include many more components such as additional radios (Bluetooth, WiFi, etc.), or any other components suitable for use in a mobile device.

Memory 410 represents a computer-readable medium capable of storing instructions, that when accessed by processor 450, result in the processor performing as described herein. For example, when processor 450 accesses instructions within sensor control component 422, processor 450 may read sensor data and detect a change in state of mobile device 100. Also for example, when processor 450 accesses instructions within NFC control component 423, processor 450 may command NFC radio 110 to change an RF signal emission status.

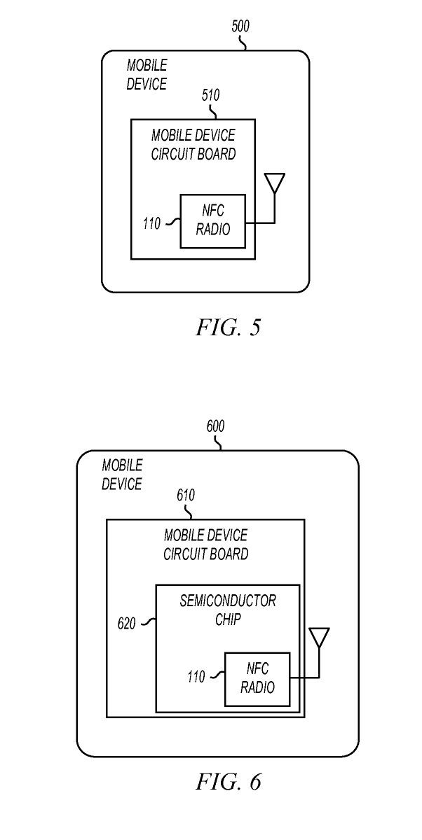

FIG. 5 shows a mobile device with a near field communications (NFC) radio on a circuit board in accordance with various embodiments of the present invention. Mobile device 500 is an example of a mobile device such as mobile device 100 in which the NFC radio is mounted on a circuit board. Mobile device 500 includes circuit board 510, which in turn includes NFC radio 110. In some embodiments, NFC radio 110 is packaged together with a secure element in a single integrated circuit such as a dual interface smartcard controller, and in other embodiments, NFC radio 110 is packaged alone. Circuit board 510 may include a processor, memory, or circuits that support other services. In some embodiments, circuit board 510 is a board that is fixed within mobile device 500 and that includes many components other than those shown.

In some embodiments, NFC radio 110 resides in an add-on slot on the circuit board, and may be removable or nonremovable. For example, in some embodiments, an add-on slot may be provided on circuit board 510 to accept NFC radio 110. In some of these embodiments, NFC radio 110 may be user accessible and removable, and in other embodiments, NFC radio 110 may be nonremovable even though it resides in an add-on slot.

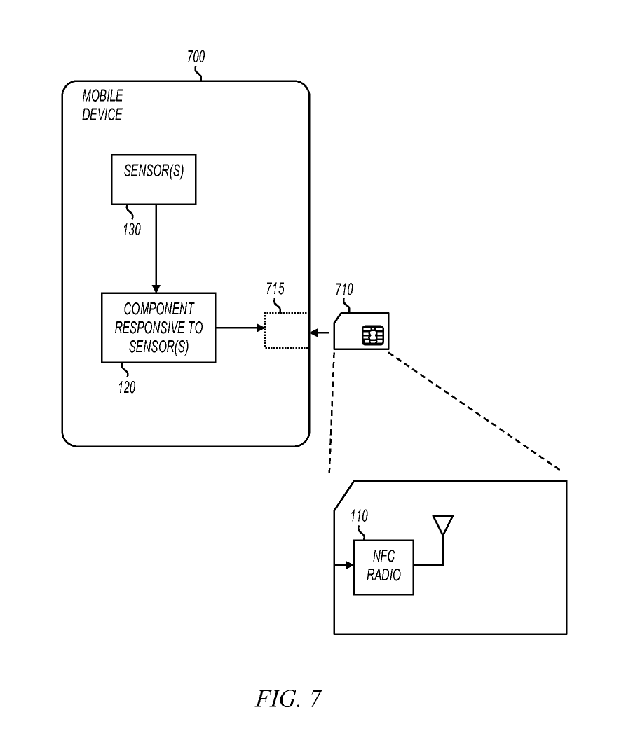

FIG. 6 shows a mobile device with an NFC radio in a semiconductor chip in accordance with various embodiments of the present invention. Mobile device 600 is an example of a mobile device such as mobile device 100 in which the NFC radio is in an integrated circuit mounted on a circuit board. Mobile device 600 includes circuit board 610, which in turn includes semiconductor chip 630. Semiconductor chip in turn includes NFC radio 110. In some embodiments, the semiconductor chip includes other functionality such as a smartcard secure element and/or a microprocessor. Circuit board 610 includes circuits that provide one or more services. For example, circuit board 610 may include a memory, a display controller, a cellular radio, or the like. In some embodiments, circuit board 610 is a board that is fixed within mobile device 600 and that includes many components other than those shown.

In some embodiments, NFC radio 110 resides in an add-on slot in the semiconductor chip, and the semiconductor chip resides in an add-on slot on the circuit board, and both may be removable or nonremovable.

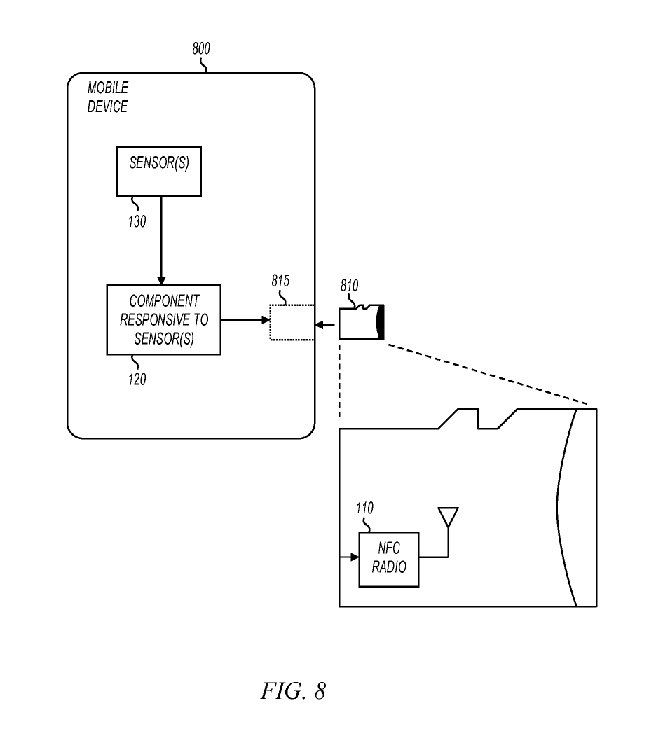

FIG. 7 shows a mobile device with an NFC radio on a subscriber identity module (SIM) card in accordance with various embodiments of the present invention. Mobile device 700 is an example of a mobile device such as mobile device 100 in which the NFC radio is mounted on a SIM card. Mobile device 700 includes SIM card 710, which in turn includes NFC radio 110. SIM card 710 includes circuits that provide one or more services. For example, SIM card 710 may include other circuits that identify a user of mobile device 700 to a mobile network operator. In some embodiments, SIM card 710 is a removable card that is inserted into an add-on slot 715 within mobile device 700 and that includes many components other than those shown. In some embodiments, SIM card 710 may be added to a non-removable add-on slot. SIM cards may be any size. For example, SIM card 710 may be a regular sized SIM card, a micro-SIM card, a nano-SIM card, or any other SIM card implementation.

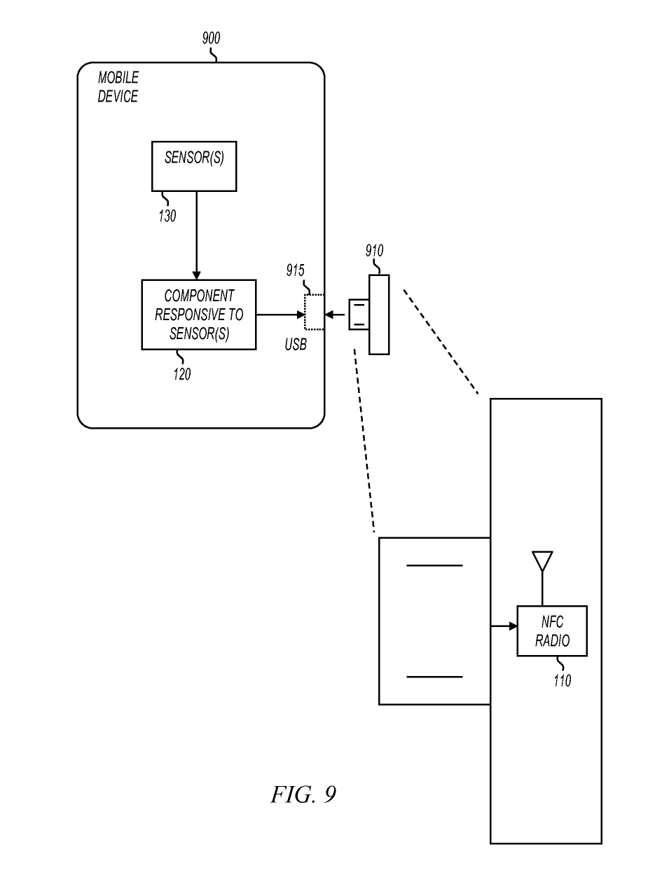

FIG. 8 shows a mobile device with an NFC radio on a memory card in accordance with various embodiments of the present invention. Mobile device 800 is an example of a mobile device such as mobile device 100 in which the NFC radio is mounted on a memory card. Mobile device 800 includes add-on slot 815. Add-on slot 815 accepts memory card 810, which is shown as a microSD memory card; however this is not a limitation of the present invention. In some embodiments, microSD memory card 810 may be added to a non-removable add-on slot. For example, system memory for mobile device 800 may be provided by memory card 810, and memory card 810 may be placed in an add-on slot in such a manner that it is nonremovable. Memory card 810 includes NFC radio 110. The combination of mobile device 800 and memory card 810 is an example of an electronic system that includes a mobile device and an add-on card that includes an NFC radio.

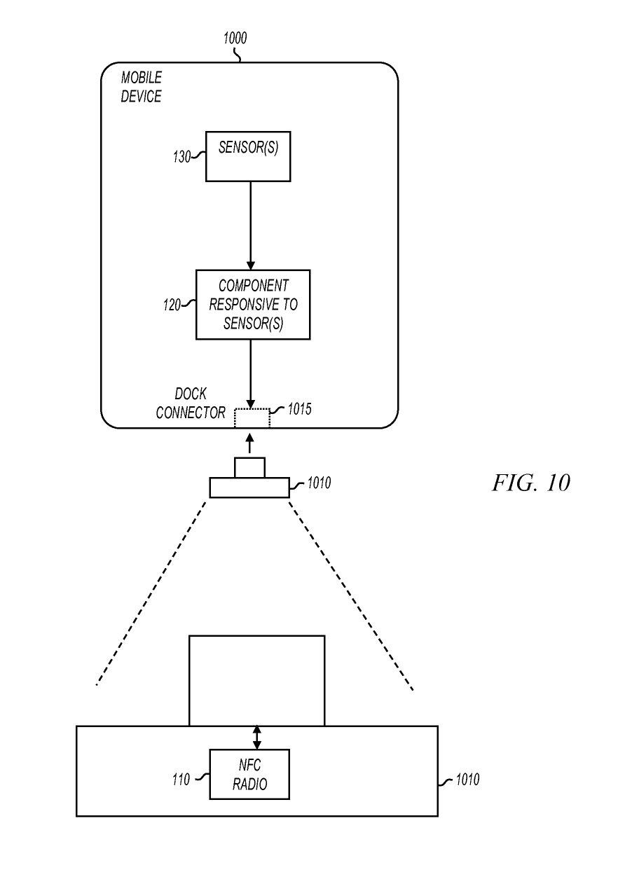

FIG. 9 shows a mobile device with an NFC radio on a universal serial bus (USB) device in accordance with various embodiments of the present invention. Mobile device 900 is an example of a mobile device such as mobile device 100 in which the NFC radio is mounted on a USB device. Mobile device 900 includes add-on slot 915. Add-on slot 915 is shown as a USB port which accepts USB dongle 910; however this is not a limitation of the present invention. Add-on slot 915 may be other than a USB port, and device or dongle 910 may be other than a USB dongle. USB dongle 910 includes NFC radio 110. The combination of mobile device 800 and USB dongle 810 is an example of an electronic system that includes a mobile device and an add-on card that includes an NFC radio.

In some embodiments the device with the NFC radio may not be physically present in an add-on slot. It may be coupled via any combination of electric, magnetic, and optical means such as Bluetooth, NFC, or infrared.

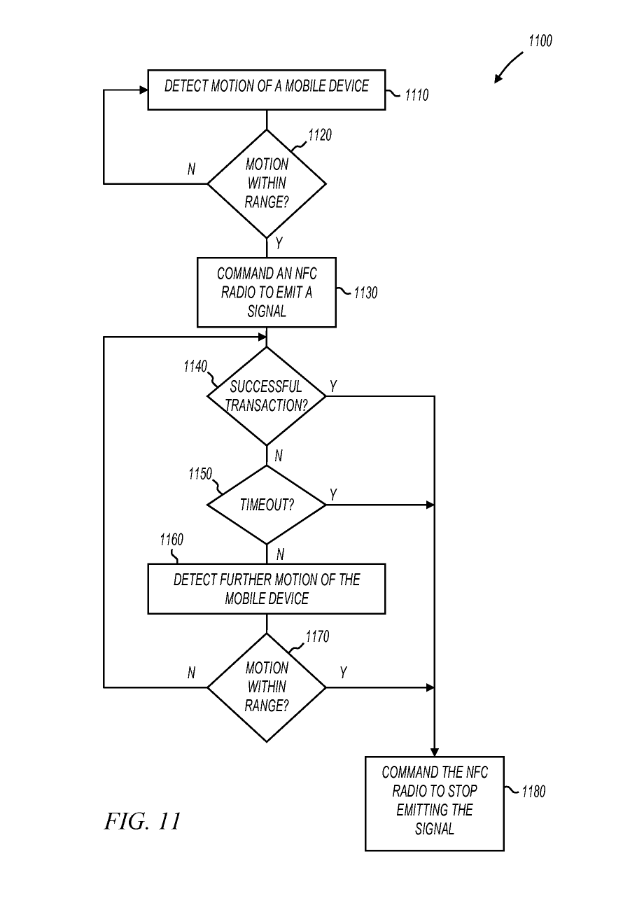

FIG. 10 shows a mobile device with a dock connector and a device compatible with the dock connector that includes an NFC radio in accordance with various embodiments of the present invention. Mobile device 1000 is an example of a mobile device such as mobile device 100 in which the NFC radio is mounted on a device compatible with a dock connector. Mobile device 1000 includes dock connector 1015. Dock connector 1015 represents an add-on slot that may be useful to connect mobile device 1000 to a removable docking device. For example, dock connector may be a 30-pin connector useful to connect mobile devices such as phones and media players to docking devices, or may be a 30-pin connector used to charge a battery within mobile device 1000. Also for example, dock connector 1015 may include more or less than 30 pins. Device 1010 is a device compatible with dock connector 1015. Device 1010 includes NFC radio 110. The combination of mobile device 1000 and device 1010 is an example of an electronic system that includes a mobile device and an apparatus that includes an NFC radio.

FIG. 11 shows a flowchart of methods in accordance with various embodiments of the present invention. In some embodiments, method 1100 may be performed by a mobile device such as any of mobile devices 100, 500, 600, 700, 800, 900, or 1000. Further, in some embodiments, method 1100 may be performed by a processor that is executing software such as sensor control component 422 and/or NFC control component 423. Method 1100 is not limited by the type of system or entity that performs the method. The various actions in method 1100 may be performed in the order presented, in a different order, or simultaneously. Further, in some embodiments, some actions listed in FIG. 11 are omitted from method 1100.

Method 1100 begins at 1110 in which motion of a mobile device is detected. In some embodiments, this corresponds to a motion sensor within a mobile device detecting motion and providing sensor data that represents the motion.

At 1120, a determination is made as to whether the detected motion is within a range. In some embodiments, the range represents a range of a single variable such as acceleration. In these embodiments, if the mobile device is accelerated by an amount within the range, then 1120 is satisfied. In other embodiments, the range represents a range of multiple variables, such as acceleration, and one or more of x, y, and z dimensions. In these embodiments, if the mobile device is accelerated in a particular dimension by an amount within the range, then 1120 is satisfied. In still further embodiments, the range represents a profile of ranges of one or more variables over time. For example, the range may be a motion profile that represents an acceleration profile over time in one or more dimensions.

If the motion is within the range as determined at 1120, then the NFC radio is commanded to emit an RF signal at 1130. This corresponds to component 120 (FIG. 1) commanding NFC radio 110 to emit an RF signal. In some embodiments, this also corresponds to processor 450 (FIG. 4) executing software instructions within NFC control component 423.

Once the NFC radio is emitting an RF signal, there are multiple scenarios under which the NFC radio will be commanded to stop emitting the RF signal at 1180. For example, as shown in FIG. 11, if a successful transaction takes place at 1140, then the NFC radio may be commanded to stop emitting the RF signal. In some embodiments, a successful transaction may include a successful transfer of information using NFC radio 110. Examples of successful transactions include, but are not limited to, the reading of an NFC tag, the exchange of pairing information with another NFC-enable device, or the like.

If a successful transaction is not performed within a specified period of time, then a timeout may occur at 1150, the NFC radio may be commanded to stop emitting the RF signal at 1180. The timeout value may be specified in any manner. For example, in some embodiments, the timeout value may be entered by a user of the mobile device. In other embodiments, the timeout value may be specified by the mobile device manufacturer or by the operating system (OS) vendor. The timeout value, and/or the method with which the timeout value is specified, are not limitations of the present invention.

In addition to the performance of a successful transaction or the occurrence of a timeout without a successful transaction, a user may cause the NFC radio to be commanded to stop emitting the RF field through additional movement. For example, at 1160, further motion of the mobile device is detected. At 1170, if the motion is within a range, then the NFC radio is commanded to stop emitting the RF signal at 1180. As discussed above with reference to 1120, the range may be a range of one or more variables at one or more points in time.

FIG. 12 shows a flowchart of methods in accordance with various embodiments of the present invention. In some embodiments, method 1200 may be performed by a mobile device such as any of mobile devices 100, 500, 600, 700, 800, 900, or 1000. Further, in some embodiments, method 1200 may be performed by a processor that is executing software such as sensor control component 422 and/or NFC control component 423. Method 1200 is not limited by the type of system or entity that performs the method. The various actions in method 1200 may be performed in the order presented, in a different order, or simultaneously. Further, in some embodiments, some actions listed in FIG. 12 are omitted from method 1200.

Method 1200 begins at 1210 in which data is received from multiple sensors. This corresponds to component 120 (FIG. 1) receiving data from multiple sensors within sensor(s) 130. Examples of multiple sensors include any combination of motion sensors, light sensors, location sensors, and the like.

At 1220, a determination is made as to whether the data is within one or more range(s). In some embodiments, each range represents a range of a single variable. For example, one range may be specified for detected motion, and a second range may be specified for a detected change in ambient light. In these embodiments, if the mobile device is accelerated by an amount within a first range, and the mobile device undergoes a change in ambient light within a second range, then 1220 is satisfied. As with 1120 (FIG. 11), the ranges may represent profiles of ranges of one or more variables over time.

If the data is within the range(s) as determined at 1220, then the NFC radio is commanded to emit an RF signal at 1130. The actions of 1130, along with the actions of 1140, 1150, and 1180 are described above with reference to FIG. 11.

As with method 1100 (FIG. 11), method 1200 may cause RF signal emissions to stop based on a change of mobile device state that satisfies particular criteria. For example, at 1260, further data is received from the sensors, and at 1270, if the data is within range(s), then the NFC radio is commanded to stop emitting the RF signal at 1180.

As described above with reference to FIGS. 11 and 12, the actions of 1110, 1160, 1210, and 1260 represent detecting a change in mobile device state. Further, the actions of 1130 and 1180 represent a change in RF signal emission status. In some embodiments, all of methods 1100 and 1200 are performed without any user interaction with a touch sensitive display device of the mobile device. For example, a mobile device may detect a change in a state of the mobile device and command an NFC radio to change an RF signal emission status based on the change in state without a user interacting with a touch sensitive screen. A display device on the mobile device may or may not provide an indication of a change in the RF signal emission status. Further, other indicia of RF signal emission status may be provided (e.g., blinking LED, haptic feedback, etc.)

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. A mobile device comprising:
a sensor to detect a change in state of the mobile device;
a near field communications (NFC) radio; and
a component configured to cause the NFC radio to change an RF signal emission status in response to the change in state of the mobile device.

2. The mobile device of claim 1 wherein the component is configured to cause the NFC radio to emit an RF signal in response to the change in state of the mobile device.

3. The mobile device of claim 1 wherein the component is configured to cause the NFC radio to stop emitting an RF signal in response to the change in state of the mobile device.

4. The mobile device of claim 1 wherein the sensor comprises a light sensor.

5. The mobile device of claim 1 wherein the sensor comprises a motion sensor.

6. The mobile device of claim 1 wherein the sensor comprises a location sensor.

7. The mobile device of claim 1 wherein the component comprises a processor and a memory with software instructions to be executed by the processor.

8. The mobile device of claim 1 further comprising a display device, and wherein the component is further configured to cause the NFC radio to change an RF signal emission status without modifying contents of the display device.

9. The mobile device of claim 1 further comprising a display device configured to modify contents of the display device when there is a change in RF signal emission status.

10. The mobile device of claim 1 wherein the mobile device comprises a mobile phone.

11. The mobile device of claim 1 wherein the change in state of the mobile device corresponds to time series of values from the sensor.

12. A mobile device comprising:
a touch sensitive display device;
a sensor to sense a change in state of the mobile device;
a near field communications (NFC) radio; and
a component configured to command the NFC radio to change a radio frequency (RF) signal emission status in response to the sensor without any user interaction with the touch sensitive display device.

13. The mobile device of claim 12 wherein the component is configured to cause the NFC radio to emit an RF signal in response to the sensor.

14. The mobile device of claim 12 wherein the component is configured to cause the NFC radio to stop emitting an RF signal in response to the sensor.

15. The mobile device of claim 12 wherein the NFC radio comprises a smartcard controller.

16. The mobile device of claim 12 further comprising a circuit board, wherein the NFC radio comprises an integrated circuit mounted to the printed circuit board.

17. The mobile device of claim 12 further comprising a subscriber identity module (SIM) card upon which the NFC radio is mounted.

18. The mobile device of claim 12 further comprising a memory card upon which the NFC radio is mounted.

19. The mobile device of claim 12 wherein the mobile device comprises a mobile phone.

20. A method comprising:
detecting motion of a mobile device; and
commanding a change in the emission status of a near field communications (NFC) radio frequency (RF) signal in response to the motion.

21. The method of claim 20 wherein commanding a change in the emission status of an NFC RF signal comprises commanding an NFC radio to emit the RF signal.

22. The method of claim 20 wherein commanding a change in the emission status of an NFC RF signal comprises commanding an NFC radio to stop emitting the RF signal.

23. The method of claim 20 wherein detecting motion of a mobile device comprises detecting motion of a mobile phone.

24. The method of claim 20 wherein commanding a change in the emission status of an NFC RF signal comprises commanding an NFC radio on a subscriber identity module (SIM) card.

25. The method of claim 20 wherein commanding a change in the emission status of an NFC RF signal comprises commanding an NFC radio on a memory card.

26. The method of claim 20 wherein commanding a change in the emission status of an NFC RF signal comprises commanding an NFC radio on a circuit board.
